(19) United States
(12) Patent Application Publication
(10) Pub. No.: US 2011/0259436 A1
(43) Pub. Date: Oct. 27, 2011

(54) SHEAR-PIN RELIEF VALVE

(76) Inventor: Donald Keith Fritts, Broken Arrow, OK (US)

(21) Appl. No.: 12/768,207

(22) Filed: Apr. 27, 2010

(51) Int. Cl. F16K 17/14

(52) U.S. Cl. 137/68.17

(57) ABSTRACT

A pressure relief valve that controls pressure by two features: the combination of the diameter and tensile strength of the shear pin used and the offset placement of the valve shaft relative to the center of the pallet to which it attaches. The shaft that has ends extending through the valve body to the exterior of the valve and a breaking arm attached to each end. Each arm cooperates with a pin receiver attached to the valve body to hold opposite ends of a shear pin therebetween when the valve is closed. As pressure is applied to the pallet, the breaking arms rotate and shear the web portion of the pins at a very accurate and repeatable opening pressure, allowing the pallet to open. The pins can be replaced and the valve reset without removing the valve from service. One or more shear pins may be employed.

### BACKGROUND OF THE INVENTION

1. Field of the Invention

The present invention relates to a pressure relief valve, and more specifically, to a pressure relief valve that employs one or more shear pins as a means of providing a very accurate and repeatable opening pressure. The present pressure relief valve is provided with shear pins that are accessible externally on the valve so that they can be readily replaced without taking the valve out of service.

2. Description of the Related Art

All prior art pin valves known to the inventor place the pin in compression along the longitudinal axis and the pressure force causes the pin to bend until it fails. The pin is either placed in the center of the seat or to one side of the seat and opens on a hedged door. Neither of these two design types uses the shaft position to control the set pressure and neither places the pin in the shear failure position in order to obtain opening. Also, nether design uses two pins which increase the reliability.

The present invention is a shear-pin pressure relief valve that is designed to provide primary and secondary pressure relief in all pressurized enclosures. Two features designed into the device control the opening pressure.

The first feature is the diameter and tensile strength of the pin or pins used with the valve. These pins are sheared when sufficient pressure loading is provided on the valve and when they shear, this allows the valve to open.

The second feature is the placement of the valve shaft. The pallet rotates around the valve shaft when the valve opens. If the valve shaft were placed in the center of the pallet, the pressure force is equal on either side of the shaft and thus pressure exerted on the pallet will not cause it to open. When the valve shaft is offset from center, the side that the shaft is moved toward experiences less pressure force due to the reduced exposed surface area of the pallet on that side of the shaft, and the side away from the shaft sees more pressure force due to the increased exposed surface area. The shaft is connected to the pallet and they rotate together to thus provide the force needed to break the pin or pins at a predetermined pressure set point.

Attached at both ends of the shaft are breaking arms that rotate with the shaft when the shaft and pallet rotate. Each shear pin is inserted into an opening provided in one of the breaking arms and also inserts into an opening provided externally on the valve housing so that a central milled web portion of each pin is held between its associated breaking arm and the stationary valve housing. When the force on the pallet exceeds the shear strength of the pin or pins, the pin or pins break or shear at their web portions, thereby allowing the pallet to open and relieve the excess pressure.

This valve is designed to provide immediate full line pressure relief upon the shearing of the shear pins. Once the valve has relieved the required pressure, the pallet can be reclosed and new shear pins installed to reset and place the valve back in service. The valve is designed to all the replacement of the pins without removing the valve from service. This is a full dovetail o-ring placed in the outside diameter of the pallet which seals the pallet against the valve ring in the body of the valve. Attached to the pallet via the shaft is the shear pin breaker arm, which is in contact with the shear pin. The pressure force is concentrated at the point where the shear pin breaker arm and the shear pin meet. This valve can be manufactured in any piping connection, flanged, threaded, vacuum or sanitary and any known metals. The valve can either be a right angle or flow through configuration. The valve will operate in all phases of service, such as liquid, gas, steam or multi-phase flow.

### SUMMARY OF THE INVENTION

The present invention is a shear-pin pressure relief valve that is designed to provide primary and secondary pressure relief in all pressurized enclosures. Two features designed into the device control the opening pressure.

The first feature is the diameter and tensile strength of the pin or pins used with the valve. These pins are sheared when sufficient pressure loading is provided on the valve and when they shear, this allows the valve to open.

The second feature is the placement of the valve shaft. The pallet rotates around the valve shaft when the valve opens. The valve shaft is offset from center to provide disproportionate pressures on either side of the shaft. The side that the shaft is moved toward from the center of the pallet experiences less pressure force due to the reduced exposed surface area of the pallet on that side of the shaft, and the side that the shaft is moved away from the center of the pallet experiences more pressure force due to the increased exposed surface area of the pallet on that side of the shaft. Thus, the amount of pressure exerted on the shaft in order to turn it is directly dependent upon the offset placement of the valve shaft relative to the center of the pallet. The shaft is connected to the pallet and they rotate together to thus provide the force needed to break the pin or pins at a predetermined pressure set point in order to allow the pallet to open within the valve housing.

Attached at both ends of the shaft and external to the valve housing are breaking arms that rotate with the shaft when the shaft and pallet rotate. One end of a shear pin is inserted into an opening provided in each of the breaking arms. An opposite end of each shear pin also inserts into an opening provided externally on the valve housing so that a weakened, central milled web portion of each pin is held between its associated breaking arm and the stationary valve housing. Because the pallet, shaft, and the attached breaker arms concentrate the pressure on the web portion of the pins, when the opening force on the pallet exceeds the shear strength of the pins, the pins are sheared at their web portions, thereby allowing the pallet to open and immediately relieving the excess pressure on the valve.

This valve is designed to provide immediate full line pressure relief upon the shearing of the shear pins. Once the valve has relieved the required pressure, the pallet can be reclosed and new shear pins installed to reset and place the valve back in service. The valve is designed to allow the replacement of the pins without removing the valve from service. The valve is provided with a full dovetail o-ring placed in the outside diameter of the pallet which seals the pallet against the valve ring in the body of the valve and prevents pressure leakage until the pins are sheared and the valve opens.

This valve can be manufactured in any piping connection, flanged, threaded, vacuum or sanitary and any known metals. The valve can either be a right angle or flow through configuration. The valve will operate in all phases of service, such as liquid, gas, steam or multi-phase flow.

### BRIEF DESCRIPTION OF THE DRAWINGS

FIG. 1 is side view of shear-pin pressure relief valve constructed in accordance with a preferred embodiment of the present invention with the direction of flow into the valve indicated by Arrow F.

FIG. 2 is a view of the valve of FIG. 1 taken along line 2-2 of FIG. 1 with internal features of the valve shown in broken lines.

FIG. 3 is an exploded view of the valve of FIG. 1.

FIG. 4 is an inlet view of the valve of FIG. 1.

FIG. 5 is an outlet view of the valve of FIG. 1.

FIG. 6 is a cross-sectional view taken along line 6-6 of FIG. 1.

FIG. 7 is an enlarged view of the area with circle 7 of FIG. 6.

FIG. 8 is an enlarged view of the pallet, shaft, bushings, and one breaking arm and shear pin as they would appear removed from the valve body.

FIG. 9 is an enlarged view of the shear pin shown in FIG. 8.

### DETAILED DESCRIPTION OF THE PREFERRED EMBODIMENT

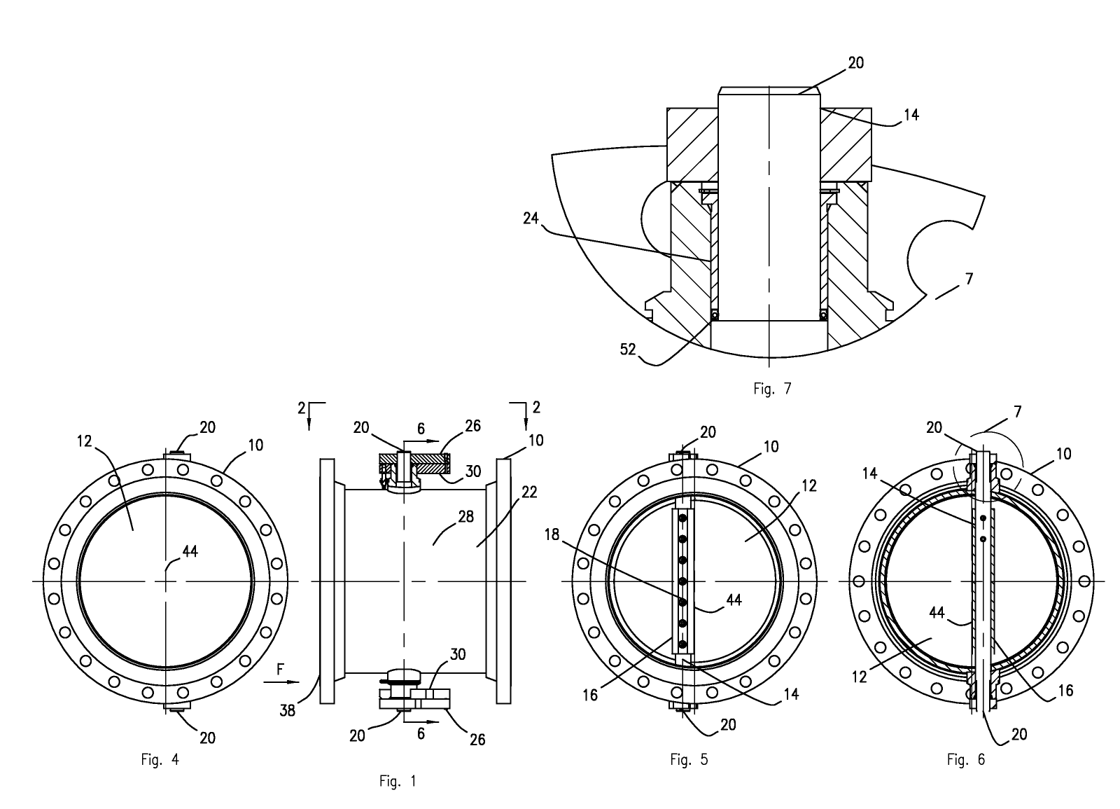

Referring now to the drawings and initially to FIGS. 1, 2 and 3, there is illustrated a shear-pin pressure relief valve 10 constructed in accordance with a preferred embodiment of the present invention. The flow direction into the valve is indicated by Arrow F in FIG. 1. This valve 10 is designed to provide primary and secondary pressure relief in all pressurized enclosures.

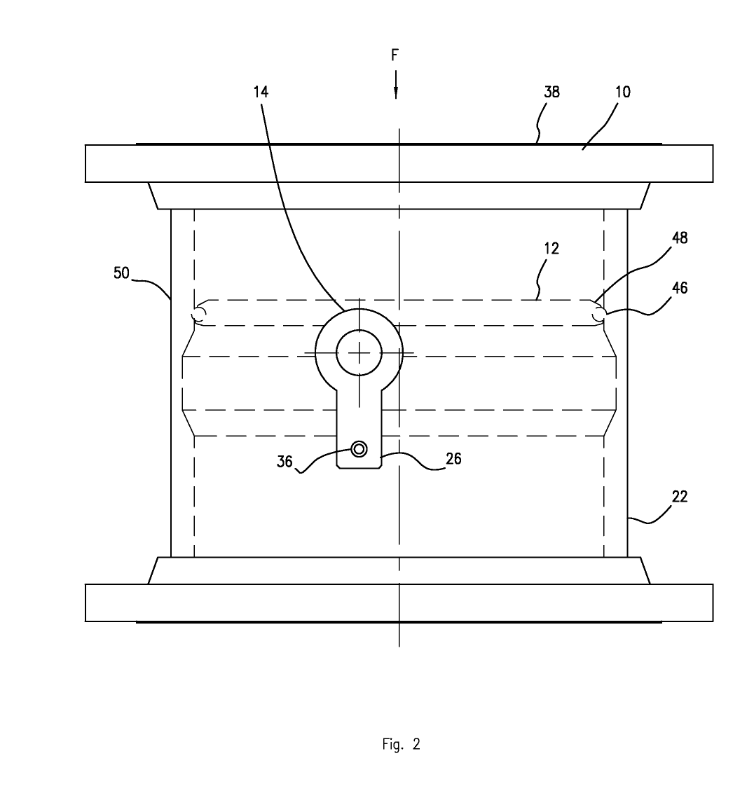

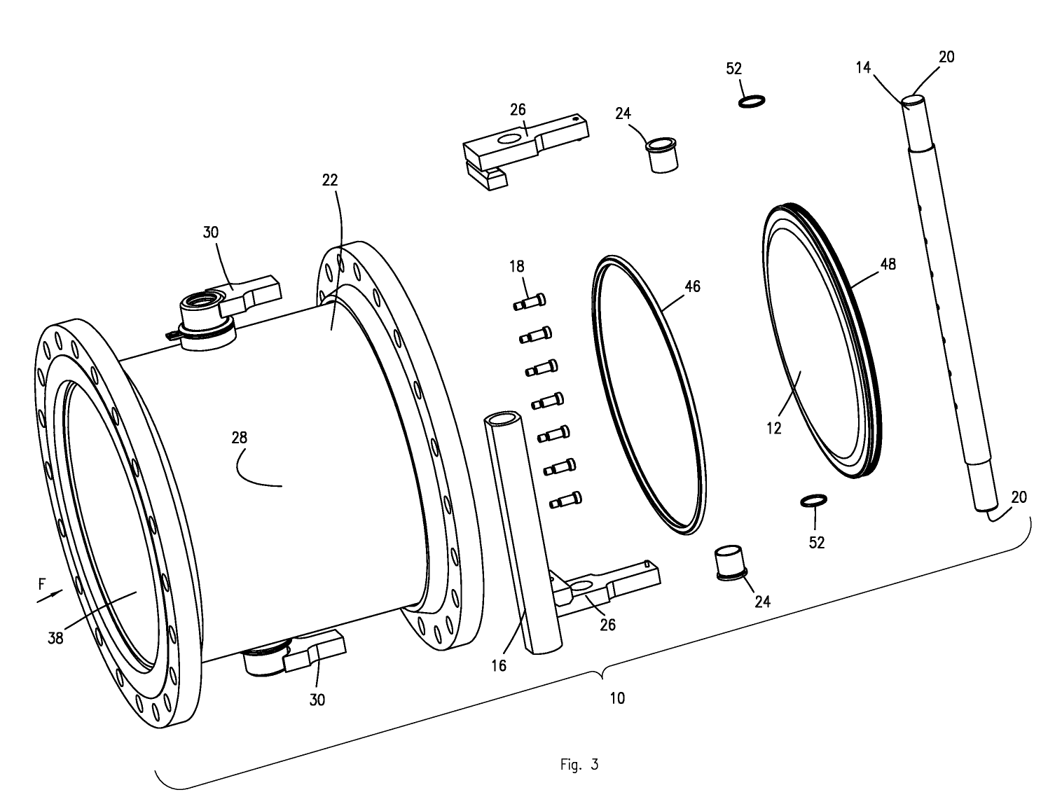

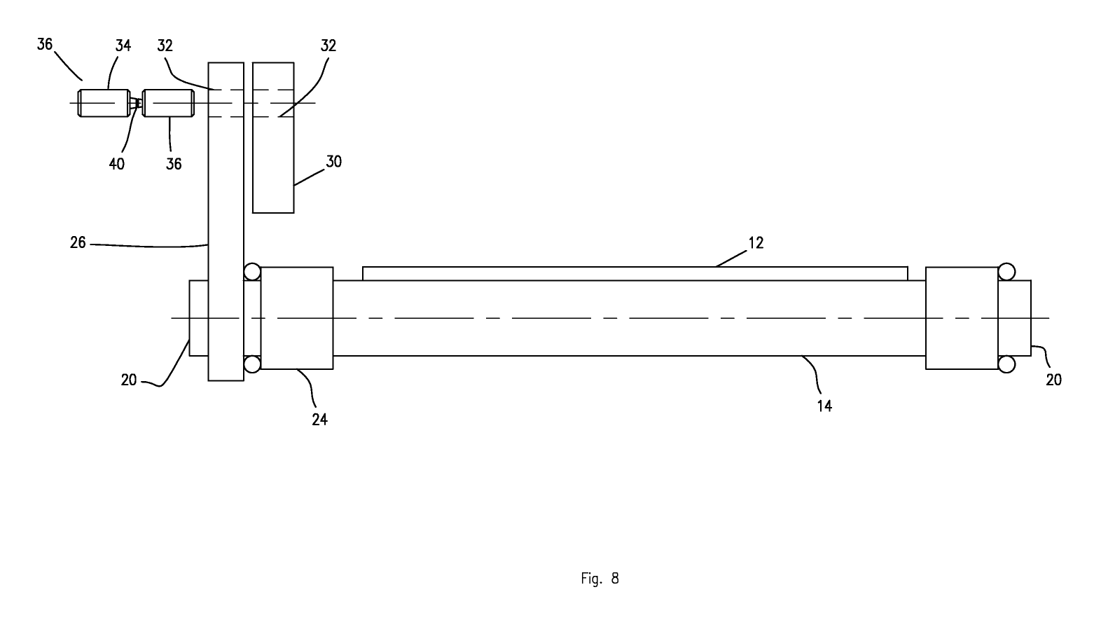

As also illustrated in FIGS. 4, 5, and 6, the valve 10 is provided internally with a pallet 12 that is attached to a shaft 14 so that the pallet 12 and shaft 14 rotate together. The pallet 12 attaches to the shaft 14 via a welded bushing 16 and screws 18. Referring also to FIGS. 7 and 8, the two ends 20 of the shaft 14 extend out of the valve body 22 through t-bushings 24. A breaking arm 26 is secured to each end 20 of the shaft 14 so that the breaking arms 26 rotate with the shaft 14 and pallet 12. Attached to the outside or external surface 28 of the valve body 22 adjacent to the ends 20 of the shaft 14 are shear pin receivers 30 that are fixed and stationary relative to the valve body 22. Each shear pin receiver 30 and each breaking arm 26 is provided with shear pin opening 32 therein for receiving one of the two ends 34 of a shear pin 36. When the pallet 12 is closed within the valve, the shear pin opening 32 of each breaking arm 26 aligns with the shear pin opening 32 of its associated shear pin receiver 30 so that a shear pin can be inserted through the shear pin opening 32 of the breaking arm 26 so that one end 34 of the shear pin 36 resides in the shear pin opening 32 of the breaking arm 26 and the other end 34 of the shear pin 36 resides in the shear pin opening 32 of the associated shear pin receiver 30.

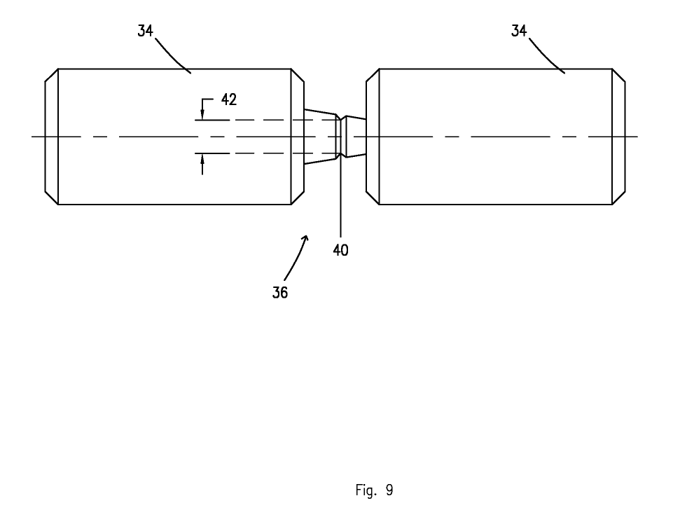

Referring also to FIG. 9, when the force exerted on the pallet 12 by the pressure at the inlet 38 of the valve 10 exceeds the shear strength of the pins 36, the pins 36 are sheared at their web portions 40. The web portion 40 is that weaker, narrow milled area of the pin 36 that connects the two ends 34 of each of the pins 36. Shearing of the pins 36 allows the breaking arms 26, the shaft 14 and the pallet 12 to rotate, thereby opening the pallet 12 and relieving the excess pressure through the valve.

Two features designed into the valve 10 control the valve's opening pressure. Referring to FIG. 9, the first feature is the diameter 42 of the central milled web portion 40 of the pins 36 in combination with the tensile strength of the pins 36 used with the valve 10. The pins 36 are machined to precisely control the diameter 42 of the central web portion 40 and the tensile strength of the pins 36 is determined by the material from which the pins 36 are constructed. These pins 36 are designed to be sheared when sufficient pressure loading is provided on the valve pallet 12. When the pins 36 are sheared, this allows the valve 10 to open.

The second feature is the placement of the valve shaft 14 relative to the center line 44 of the pallet 12. The pallet 12 rotates around the valve shaft 14 when the valve 10 opens. If the valve shaft 14 were placed on the center line 44 of the pallet 12, the pressure or force exerted on the pallet 12 would be equal on either side of the shaft 14 and thus the pressure exerted on the pallet 12 will not cause the pallet 12 to open relative to the valve body 22. When the valve shaft 14 is offset from the center line 44 of the pallet 12, the smaller side of the pallet 12 experiences less pressure force due to the reduced exposed surface area of the pallet 12 on that side of the shaft 14, and the larger side of the pallet 12 sees more pressure force due to the increased exposed surface area on that side of the shaft 14. The shaft 14 is attached to the pallet 12 and they rotate together to thus provide the force needed to move the breaking arms 36 and thereby shear the pins 36 at a predetermined pressure set point.

This valve 10 is designed to provide immediate full line pressure relief upon the shearing of the shear pins 36. Once the valve 10 has relieved the required pressure, the pallet 12 can be reclosed and new shear pins 36 installed to reset the valve 10 and place it back in service. The valve 10 is designed to all the replacement of the pins 36 without removing the valve 10 from service.

There is a full dovetail o-ring 46 placed in the outside diameter 48 of the pallet 12 which seals the pallet 12 against the valve ring 50 in the body 22 of the valve 10 to prevent leakage around the pallet 12 prior to the pallet 12 being opened. Also, o-ring seals are provided at the t-bushings 24 so that there is no leakage around the shaft 14.

This valve 10 can be manufactured in any piping connection such as flanged, threaded, vacuum or sanitary and can be constructed of any known metals. The valve 10 can either be a right angle or flow through configuration. The valve 10 will operate in all phases of service, such as liquid, gas, steam or multi-phase flow.

Although the valve 10 has been described as employing two breaking arms 26, with one breaking arm 26 and its associated shear pin 36 attaching at either end 20 of the shaft 14, the invention is not so limited. Although breaking arms 26 on each end 20 of the shaft 14 reduces the torsion loading on the shaft 14, the invention can be practiced employing only one breaking arm 26 and an associated shear pin 36 located on only one end 20 of the shaft 14.

While the invention has been described with a certain degree of particularity, it is manifest that many changes may be made in the details of construction and the arrangement of components without departing from the spirit and scope of this disclosure. It is understood that the invention is not limited to the embodiments set forth herein for the purposes of exemplification, but is to be limited only by the scope of the attached claim or claims, including the full range of equivalency to which each element thereof is entitled.

What is claimed is:

1. A pressure relief valve comprising:
a valve pallet pivotally provided within a valve body, said pallet attached to a valve shaft so that the pallet and shaft rotate together, at least one end of the shaft extending through the valve body, a breaking arm secured to at least one end of the shaft so that the breaking arm rotates with the pallet and shaft, opposite ends of a shear pin held between the breaking arm and the valve body when the valve is closed so that the pin is sheared when the breaking arm rotates with the pallet and shaft to open the valve.

2. A pressure relief valve according to claim 1 wherein said shear pin is constructed of a material with the desired tensile strength so that the shear pin will shear when a desired force is applied to it by its associated breaking arm.

3. A pressure relief valve according to claim 2 wherein said shear pin is constructed with a central web portion with a diameter so that the shear pin will shear when a desired force is applied to it by its associated breaking arm.

4. A pressure relief valve according to claim 3 wherein the valve pallet is secured to the valve shaft offset from the center of the pallet to achieve the desire unequal surface areas of the pallet located on either side of the valve shaft in order to exert opening force on the pallet when the valve is pressurized.

5. A pressure relief valve according to claim 1 wherein the valve pallet is secured to the valve shaft offset from the center of the pallet to achieve the desire unequal surface areas of the pallet located on either side of the valve shaft in order to exert opening force on the pallet when the valve is pressurized.

6. A pressure relief valve according to claim 1 further comprising:
each end of the shaft extending through the valve body, a breaking arm secured to each end of the shaft, a shear pin held between each breaking arm and the valve body so that the pins are sheared when the breaking arm rotates.

7. A pressure relief valve according to claim 6 further comprising:
two pin receivers secured to the valve body to hold one end of each of the shear pins to the valve body so that each shear pin is held between a pin receiver and its associated breaking arm.

8. A pressure relief valve according to claim 6 further comprising:
bushings provided in the valve body through which the ends of the shaft extend so that the ends of the shaft are located on the outside of the valve body.

9. A pressure relief valve according to claim 1 further comprising:
at least one bushing provided in the valve body through which at least one end of the shaft extends.

10. A pressure relief valve according to claim 1 further comprising:
at least one pin receiver secured to the valve body to hold one end of the shear pin to the valve body and between the valve body and its associated breaking arm.
